(19) United States
(12) Patent Application Publication
(10) Pub. No.: US 2008/0232359 A1
(43) Pub. Date: Sep. 25, 2008

(54) FAST PACKET FILTERING ALGORITHM

(76) Inventors: Taeho Kim, Dallas, TX (US); Frederick Skoog, Colleyville, TX (US)

Correspondence Address: ALCATEL LUCENT;INTELLECTUAL PROPERTY & STANDARDS, 3400 W. PLANO PARKWAY, MS LEGL2, PLANO, TX, 75075, US

(21) Appl. No.: 11/690,742

(22) Filed: Mar. 23, 2007

(51) Int. Cl. H04L 12/56

(52) U.S. Cl. 370/389

(57) ABSTRACT

Packets received at a network element are filtered according to a plurality of filtering rules, where each filtering rule includes filtering data associated with one or more fields of a received packet. Rule groups are defined to include a plurality of filtering rules having common associated fields. For each rule group, global filter masks are generated, where bit positions in the global filter mask indicate whether each filtering rule in the rule group has a predetermined value at a corresponding bit position. As packets are received, comparing the global filter masks to one or more fields in the packets to determine whether there is a possibility that one of the rules in a corresponding rule group will match data in the fields.

### STATEMENT OF FEDERALLY SPONSORED RESEARCH OR DEVELOPMENT

The U.S. Government has a paid-up license in this invention and the right in limited circumstances to require the patent owner to license others on reasonable terms as provided for by the terms of Award No. 70NANB3H3053 awarded by National Institute of Standards and Technology.

### CROSS-REFERENCE TO RELATED APPLICATIONS

Not Applicable

### STATEMENT OF FEDERALLY SPONSORED RESEARCH OR DEVELOPMENT

Not Applicable

### BACKGROUND OF THE INVENTION

1. Technical Field

This invention relates in general to data networks and, more particularly, to a fast packet filtering method and apparatus.

2. Description of the Related Art

Within a data network, many network elements may need to filter (e.g., identify or classify) incoming packets. This filtering process involves comparing information at certain fields of a packet (typically header fields, but, in some cases, fields in the payload) with various filtering rules. Each filtering rule is a set of values that may be found in one or more designated fields in the header or payload. The filtering process may occur at any layer above the physical layer (layer 1).

With multiple packet filtering rules, filtering packets can be a tedious and resource-consuming task that may introduce significant packet delay variations by the network elements. The computation time for filtration of packets is proportional to the number of comparisons in the rule with the value(s) contained in the specific field(s). The computation time naturally increases as the bandwidth (more specifically, number of packets) and number of rules increase. Computation time for packet filtration increases linearly, O(N), where N is the number of rules, by the multitude of number of rules where rules contain only one lookup field from a packet. The computation time becomes O(N²) where the filtration rules require multiple field lookups. For example, let there are X rules and Y packets. Then average number of comparisons needed to find a matching rule is (X/2) and overall average number of comparisons is Y*(X/2)==O(N²). The computation time increase for filtration becomes burdensome, and even unacceptable, to the packet processor.

Further, where packet filtering rules change frequently, it is not a good practice to hard-code the packet filtering rules in packet processing engine, so a hardware based solution is generally not feasible.

More efficient search techniques, such as a tree search or a binary search, could be used, but a tree search will not reduce the complexity of the search and a binary search is not suitable for packet filtering since the characteristics of rule searching is not binary by its nature.

Therefore, a need has arisen for a faster packet filtering method that can be efficiently performed in software.

### BRIEF SUMMARY OF THE INVENTION

In the present invention, packets received at a network element are filtered according to a plurality of filtering rules, where each filtering rule includes filtering data associated with one or more fields of a received packet. Rule groups are defined to include a plurality of filtering rules having common associated fields. For each rule group, global filter masks are generated, where bit positions in the global filter mask indicate whether each filtering rule in the rule group has a predetermined value at a corresponding bit position. As packets are received, comparing the global filter masks to one or more fields in the packets to determine whether there is a possibility that one of the rules in a corresponding rule group will match data in the fields.

The present invention provides significant advantages over the prior art. A significant number of comparison operations can be avoided by the comparison of the global filter mask to the packet fields, prior to performing a search on the individual rules.

### BRIEF DESCRIPTION OF THE SEVERAL VIEWS OF THE DRAWINGS

For a more complete understanding of the present invention, and the advantages thereof, reference is now made to the following descriptions taken in conjunction with the accompanying drawings, in which:

FIG. 1 illustrates a generalized network element that receives and sends packets over a network

FIG. 2 illustrates operation of a Fast Packet Filtering Method with two Rule Groups;

FIG. 3 is a flow chart showing the operations performed in the processing circuitry of the network element to implement a preferred embodiment of the Fast Packet Filtering Method;

FIG. 4 illustrates a data structure for storing rules of a Rule Group in a linked list format;

FIG. 5 illustrates a block diagram of a simulation environment which demonstrates the benefits of the preferred embodiment of the Fast Packet Filtering Method;

FIGS. 6 and 7 illustrate the results of test performed for randomized packets comparing the Fast Packet Filtering Method to a linear search.

### DETAILED DESCRIPTION OF THE INVENTION

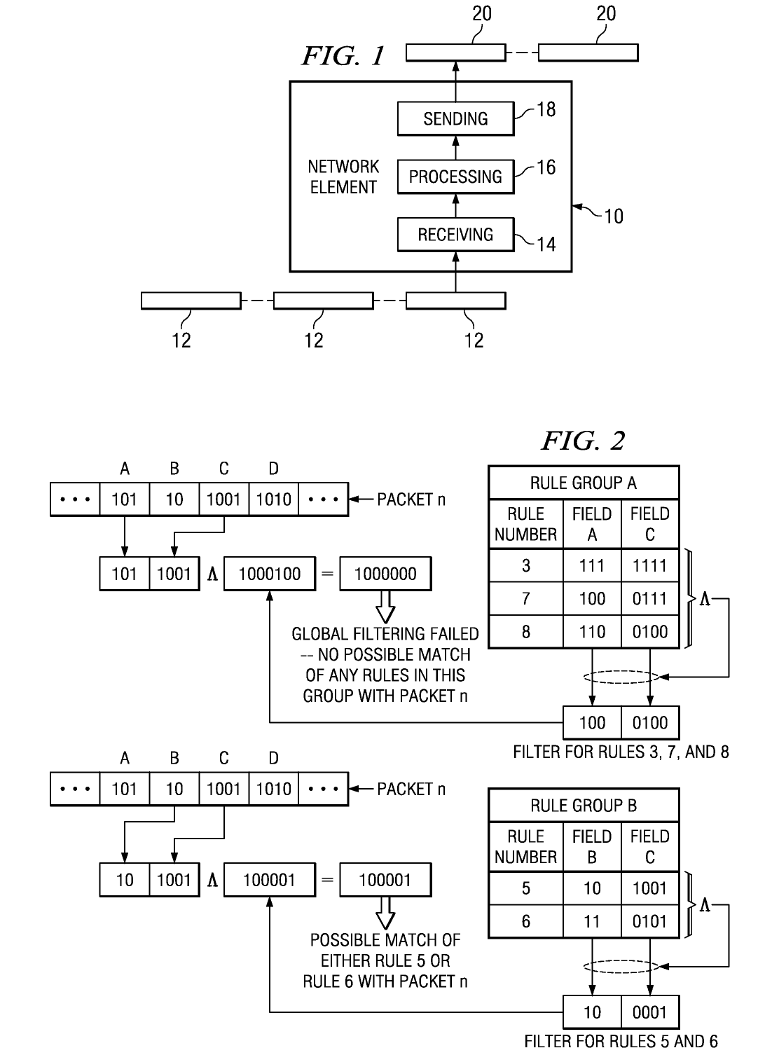

The present invention is best understood in relation to FIGS. 1-7 of the drawings, like numerals being used for like elements of the various drawings.

FIG. 1 illustrates a generalized network element 10 that receives and sends packets over a network. The incoming packets 12 are received by receiving circuitry 14, which performs the layer 1 translation of the received modulated electrical signals into binary information that can be processed using electronic circuitry. The processing circuitry 16 processes packets as needed and the sending circuitry 18 modulates information for the outgoing packets 20. The filtering described herein is performed in the processing circuitry 16.

As described below, the preferred embodiment of the present invention alleviates the computational complexity of filtering by both reducing the number of comparisons and the number of data collections from packets. The basic principles of the process are discussed in relation to FIG. 2.

Packet filtering is a technique identifying specific packets according to the filtering rules for further processing. A generalized packet filtering process includes the steps of information collection, rule search (comparison), and marking/classification.

Rule Groups are defined as a group of filtering rules, each of which requires the same field lookups. In FIG. 2, two Rule Groups are defined: Rule Group A, which includes Rules 3, 7 and 8 and Rule Group B which includes Rules 5 and 6. A Rule Group could cover one or more filtering rules.

By grouping rules, collecting information from a packet header/payload need only be performed for each new Rule Group, rather than for each rule. For example, Rule Group A includes two rules which are compared to information in fields A and C of the packet. Rule Group B includes two rules which are compared to information in fields B and C of the packet. Thus, since Rules 3, 7 and 8 are compared to the same fields, the data from fields A and C only need to be collected once for all rules. Similarly, data from fields B and C only need to be collected once for Rule 5 and Rule 6. This can significantly reduce the number of information gathering from a packet and can contribute to the reduction of time complexity.

A second significant reduction in time is provided by group filtering. When rules are grouped according to the common search fields, there can be some bits that are always 1's or 0's in the rules in the Rule Group. This common bit pattern in a Rule Group represents the characteristic of the entire rules in the group, called Rule Group Filter Mask. In the illustrated embodiment, a Rule Group Filter is the “logical-Bit-Wise-AND” operation over all rules in the Rule Group. By performing the AND operation over all the rules in the Rule Group, any bit position for which all of the Rules have a “1” will yield a “1” in the same bit position in the filter; any bit position for which at least one of the Rules has a “0” will yield a “0” in the same bit position in the filter. The logical-Bit-Wise-AND operation must be performed whenever a rule (or possibly multiple rules) in the group is updated (added/deleted/modified).

A Rule Group Filter can render important information. For any position in the Rule Group Filter that is a “1”, if the corresponding position in the packet is not a “1”, then the packet cannot match any Rule in the Rule Group.

By ANDing the relevant bits of the packet with the Rule Group Filter, it can be determined whether or not it is necessary to perform additional comparisons with the individual rules. If an AND operation between the relevant bits and the Rule Group Filter yields a result that is equal to the Rule Group Filter, then additional rule checking must be performed, since it is possible, but not certain, that at least one rule in the Rule Group will match the relevant packet data. On the other hand, if the AND operation between the relevant bits and the Rule Group Filter yields a result that is not equal to the Rule Group Filter, then additional rule checking need not be performed, since it is not possible that any rule in the Rule Group will match the relevant packet data—in this case the method proceeds to the next Rule Group.

As all the rules in an entire Rule Group are skipped when the Rule Group Filter Mask does not match, this can significantly reduce the number of comparisons.

Referring again to the example of FIG. 2, data from fields A and C are concatenated to perform a preliminary match in comparison to the Rule Group A Filter. Since the result of the AND operation does not match the Rule Group A Filter, no rule in Rule Group A can match with the packet, and a new comparison is done with the concatenation of fields B and C of the packet with the Rule Group B Filter. In this case, there is a match, so the individual rules in Rule Group B are compared with the bits of fields B and C. In this case, it turns out that there is a match with Rule 5.

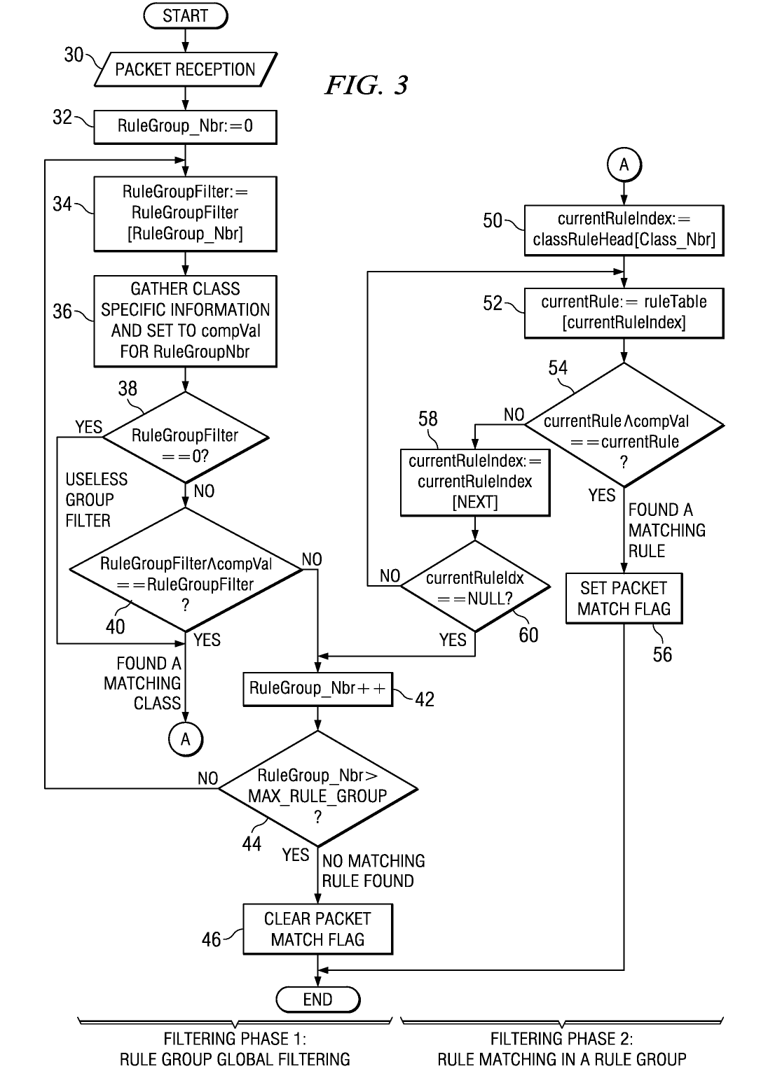

FIG. 3 is a flow chart showing the operations performed in the processing circuitry 16 of the network element 10 to implement the Fast Packet Filtering Method. The Fast Packet Filtering Method uses two phases of processing. The first phase, called Rule Group Global Filtering, gathers comparison information from the packet header and/or payload fields according to a Rule Group's definition and then compares the information with a Rule Group Filter Mask. If the AND operations yields a result that matches the Rule Group Filter Mask, the packet is processed by the second phase processing block. The second phase compares the information gathered from a packet against individual rules in the Rule Group that was identified by the previous phase, if the comparison with individual rules is necessary.

In Phase 1, Group Global Filtering, a packet is received in step 30. A first Rule Group is chosen (RuleGroup_Nbr=0) in step 32. In step 34, the Rule Group Filter for the chosen Rule Group (RuleGroupFilter[RuleGroup_Nbr]) is selected. In step 36, the appropriate fields from the packet are concatenated (compVal) to correspond to the bits of the selected Rule Group Filter. In step 38, if the Rule Group Filter is all “0s”, meaning that there is no information in the Rule Group Filter that could exclude the corresponding Rule Group from individual rule comparisons, then the flow is redirected to Phase 2, where the individual rule matching takes place. Otherwise, if the Rule Group Filter is non-zero in step 38, then, in step 40, the result of the logical ANDing of compVal (the appropriate fields from the packet) and the selected Rule Group Filter is compared to the Rule Group Filter. If these two values match, then flow continues to Phase 2; otherwise, the next Rule Group Filter is chosen in step 42, until all Rule Group Filters have been compared in step 44. Once all Rule Group Filters have been compared in step 44, without a match on any rule, the “Packet Match” Flag is cleared in step 46.

If the selected Rule Group Filter is all-zeros or if there is a match in step 40, then an index is set to specify a current individual Rule from the current Rule Group in step 50. The current individual Rule is selected at the specified index in step 52. The current Rule is compared to the compVal in step 54 using an AND operation—if the result of the AND operation is equal to the Rule there is a match. If there is a match in step 54, then the packet match flag is set in step 56 and the process is completed. Otherwise, if there is no match, the next rule of the group is specified in step 58 (a particular method of finding the next rule is described below) and if the specified Rule is not a NULL in step 60, the matching method continues at step 52. If the specified Rule is a NULL in step 60, indicating that all Rules for the Rule Group have been compared without finding a matching rule, the next Rule Group is chosen in step 42.

The method of FIG. 3 continues until a match is found between the appropriate fields of the packet and an individual rule, or until all Rule Groups have been ruled out.

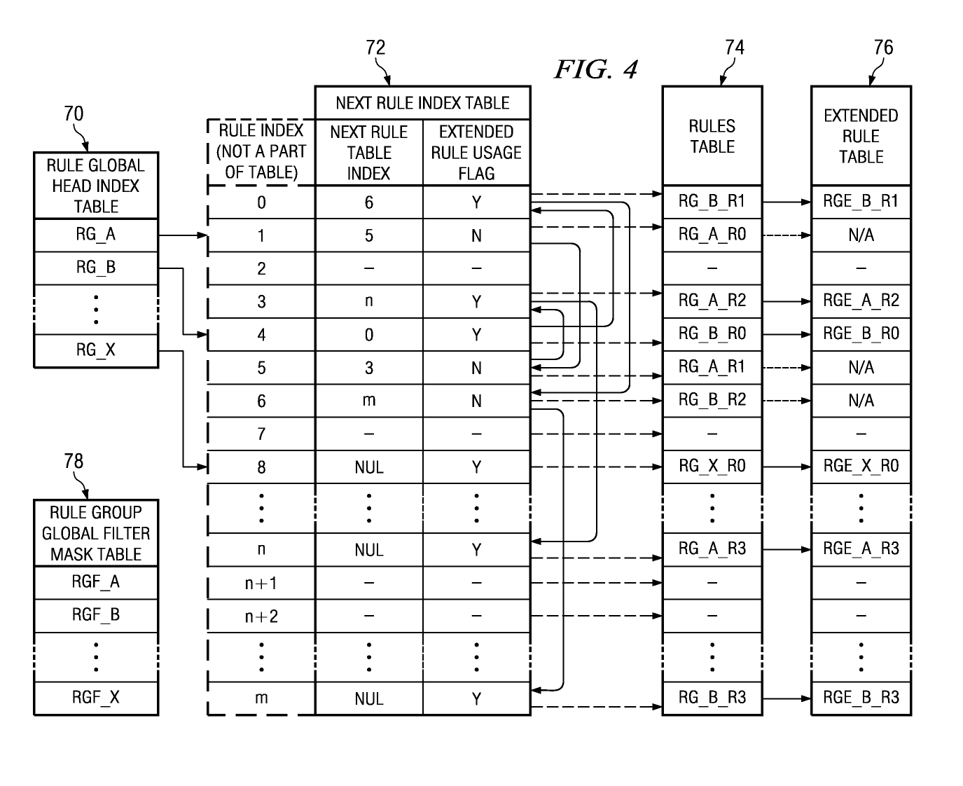

FIG. 4 illustrates a data structure for storing rules of a Rule Group in a linked list format. A Rule Group Head Index Table 70 stores the location (in a Rules Table) of the first rule in a linked list for each Rule Group. A Next Rule Index Table 72 indicates the location of the next rule in the linked list, along with whether the Rule is extended. If the Rule is not extended, then all bits of the Rule are in the Rules Table 74, with any extra bits set to “0”. On the other hand, if the Rule is extended, the bits for the Rule are stored in both the Rules Table 74 and the Extended Rule Table 76. A Rule Group Global Filter Mask Table 78 stores the Rule Group Filter for each Rule Group.

In the example of FIG. 4, the first Rule of Rule Group A is at index “1”. According to the Next Rule Index Table, the Rule at index “1” is not extended and the next Rule in the sequence is at index 5. The third Rule in the sequence for Rule Group A is at index 3 (it should be noted that in general, all rules in a rule group will be either extended or not extended; however, if the extended portion is all zeros,then the extended flag will be set to “N”, as is the case for Rule Group A). The fourth and final rule in the sequence is at index n. The pointer for the next rule is a NUL, indicating that it is the last rule in the sequence.

The Rule Group Global Filter Mask table contains the Rule Group-wide global bit masks for all Rule Groups. This table must be updated whenever there are any changes in any of the rules in the Rule Group.

Because the preferred embodiment reduces the number of comparisons and the number of data collections from packets, it can be performed with significantly less resources. The complexity of unmodified linear search method shows the average complexity of [½*(R*L)], where R is the number of rules and L is the average number of lookup fields in the rules. Since Fast Packet Filter Method can skip some group of rules, it can improve the complexity by the factor of some constant number, e.g., in the best case, more than 50%. As Fast Packet Filter Method is based on a Linear Search Method, the overall complexity of the method still remains in O(N²) category.

The method uses the five tables shown in FIG. 4: Rule Table, Extended Rule Table, Rule Head Index Table, Next Rule Index Table, and Rule Group Filter Mask Table. The total amount of space required for the method is:

M=(N_{G}*W_{H})+(N_{G}*W_{R})+(N_{R}*W_{I})+(N_{R}*W_{R})+(N_{R}*W_{E}),

where

N_{G}: Number of Rule Groups,

N_{R}: Total number of Rules,

W_{R}: Width (size) of a Rule (in octets),

W_{E}: Width (size) of a Extended Rule (in octets),

W_{I}: Width (size) of a Next Rule Index (in octets),

W_{H}: Width (size) of a Rule Group Head Index (in octets)

The method does not necessarily improve computational (time) complexity or may even increase the complexity in some cases.

A Rule Group Filter Mask is a common bit pattern made from “logical bit-wise AND” operation on all the rules in a Rule Group. When there are few (or no) common bit patterns in the rules of a Rule Group (random rules), the possibility of Rule Group Filter Mask of the Rule Group becomes all-zeros can be very high. This high possibility leads to the first phase of the method useless since all the rules in the Rule Group should be searched and this first phase comparison becomes an overhead.

When the rules are not evenly distributed among all Rules Groups, the method may spend most of the time searching a rule in one Rule Group that has dominant number of rules. In an extreme case, one Rules Group has all the rules and the others have none. When the Rule Group Filter Mask of the Rule Group matches most of the time, or all the Rule Group Filter Masks become all-zeroes, the method simply becomes a Linear Search.

On the other hand, when Rule Group Filter Mask does not match the packet most of the time, and as a consequence, most of the rule searches are skipped, the computing complexity can be reduced significantly.

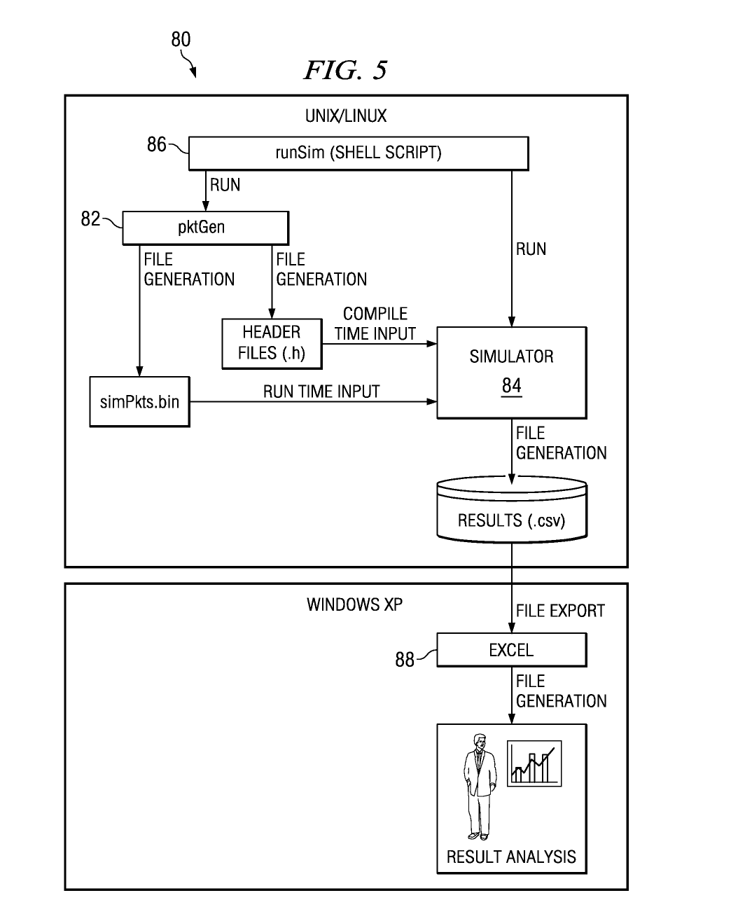

FIG. 5 illustrates a block diagram of a simulation environment 80 which demonstrates the benefits of the preferred embodiment of the present invention. The simulation environment 80 includes a packet traffic source (packet generator, or pktGEN) 82 and a packet processor (simulator) 84 that are implemented in C language, and a simulation controller (runSim) 86 to get multiple results automatically for several predefined test scenarios. The simulator 84 produces results for both Fast Packet Filtering and traditional Linear Search methods that help make quick comparisons. A spreadsheet 88, such as Microsoft Excel, is used for postmortem analysis. Excel reads the CSV file as an input and generates graphical representation of the results.

The Simulation Controller, runSim, is responsible for controlling overall simulation process, including program compilation, passing packet generation parameter to the packet generator 82, running the packet generator 82 and the simulator 84. The simulation result file name is also given to the simulator 84 by the Simulation Controller. The Simulation Controller is programmed in UNIX (Linux) shell (Bash) scripts.

The packet generator 82 controls the generation of packets by a number of given parameters and conditions during the run time. The packet generator 82 also generates multiple header files for the simulator. The packet generation control parameters are listed in Table 1.

TABLE 1
Packet Generator Runtime Options

| Option | Purpose |
|---|---|
| m | % of packets generated that match the over all rules |
| r | total number of rules |
| p | total number of packets to be generated |
| a | number of predictable bits in Class A |
| b | number of predictable bits in Class B |
| c | number of predictable bits in Class C |
| d | number of predictable bits in Class D |
| e | number of predictable bits in Class E |
| v | number of predictable bits in Class VSM |
| g | number of predictable bits for all Classes |
| h | display this help message |

The packet generator (pktGen) may be programmed in C language and it generates random (contents) packets to a binary format file (simPkts.bin). The exception of the randomness is when “number of predictable bits” parameters are given, the given number of bits in the specific positions in the packets are all set to 1's and the specified Rule(s) is(are) also properly modified.

The packet match rate is maintained using the following method: a certain number of (random) packets are saved in a table and the packets from the table are copied to simPkts.bin according to the packet match rate. The selection of the packets to be copied are randomly selected. The header files generated by the pktGen are GroupMaskTable.h, IndexTable.h, and RuleTable.h. The GroupMaskTable.h (ClassMaskTable.h) contains Rule Group Filter Masks of all the Rule Groups. The IndexTable.h contains Next Rule Indices of the Rules in the Rule Table. The RuleTable.h contains rules used by the simulator. RuleTable.h also includes the list of packet information (packet sequence number and its matching rule number) that are supposed to be matched with the rules by the simulator and the list is in C language comments format for (human) debugging.

The simulator 84 is responsible for generating the result files according to the given method, the given rules, and the input packets. The simulator is written in C and simulator is recompiled to accommodate new header files generated by the pktGen according to a new test scenario. The simulator, then, reads packet information from simPkts.bin file simulating the packet receptions. The packet information is then processed (filtering) and statistics are collected and saved into a result file. The result file is in “Comma Separated Value” (CSV) format for analysis tool(s).

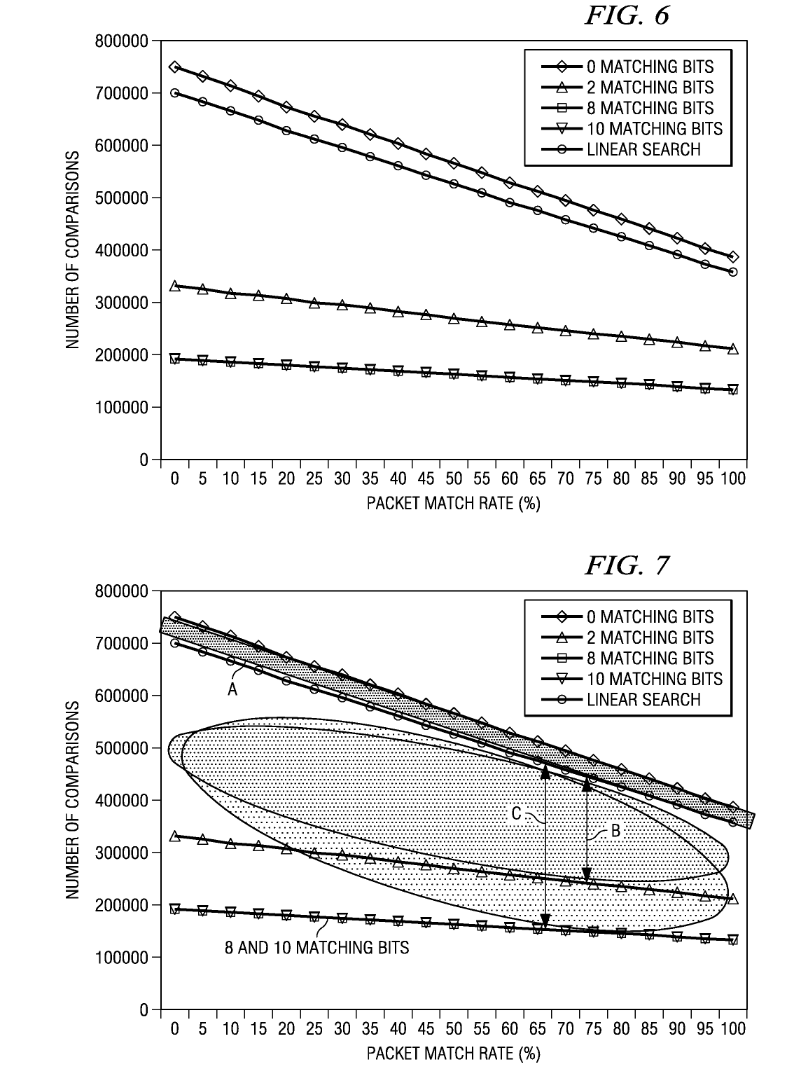

Results are provided in FIGS. 6 and 7. In this example, 70 filtering rules are evenly distributed in five Rule Groups (i.e., twelve rules in each Rule Group). Each filtering rule is a 32-bit wide pattern. The simulation run provides 10,000 packets with controlled bit patterns.

Referring to FIG. 6, the packet generator generates a packet with random bit pattern. Once a packet is generated, one Rule Group is chosen randomly. The bit positions that contain 1 in that Rule Group Filter are selected randomly. The number of selected bit positions is controlled by number of matching bits set for the specific given simulation condition (e.g., 0, 2, 8, 10 in this example). In this Figure, the lines for 8 and 10 matching bits are substantially overlapping, so it appears as one line.

To control the packet match rate, one rule in the Rule Group is chosen and copied into the packet. The rate of this rule copy depends on the “Packet Match Rate” (X-axis in the graph). The packets that are out of the controlled match rate are not touched in this phase so that the rest of the bits except the chosen bits in the previous phase are still in random pattern.

Thus, the resulting chart is obtained by controlling two parameters: number of matching bits in the Rule Group Filer and the rule matching rate. FIG. 7 shows a visual presentation of the results. From FIG. 7, four distinctive differences relative to a traditional linear search method can be identified, as described below.

First, when there are no matching bits (no packet matches any rule), as shown in area “A”, the number of comparisons using the proposed algorithm is larger than that for a linear search algorithm regardless of packet match rate settings. This is due to the extra comparison required to search the Global Rule Filter in addition to the linear search of the rules contained in all rule groups.

Second, as the number of matching bits is increased to two, a significant reduction of number of comparisons relative to a linear search is observed as shown in area “B”.

Third, when the number of matching bits increased to eight, significant performance improvement is observable as depicted in area “C”.

Fourth, when the number of matching bits increases from 8 to 10, the performance improvement becomes relatively smaller but it still shows significant performance improvement.

Accordingly, the present invention provides significant advantages over the prior art.

Although the Detailed Description of the invention has been directed to certain exemplary embodiments, various modifications of these embodiments, as well as alternative embodiments, will be suggested to those skilled in the art. The invention encompasses any modifications or alternative embodiments that fall within the scope of the Claims.

1. A method of filtering packets received at a network element according to a plurality of filtering rules, where each filtering rule includes filtering data associated with one or more fields of a received packet, comprising the steps of:
defining rule groups including a plurality of filtering rules having common associated fields;
generating a global filter masks for each rule group, where bit positions in the global filter mask indicate whether each filtering rule in the rule group has a predetermined value at a corresponding bit position;
as packets are received, comparing the global filter masks to one or more fields in the packets to determine whether there is a possibility that one of the rules in a corresponding rule group will match data in the fields.

2. The method of claim 1 and further comprising the step of concatenating fields from the packet to form a compare value to compare with a global filter mask.

3. The method of claim 2 wherein bit positions of the compare value are compared with corresponding positions of an associated global filter mask with a logical AND operation.

4. The method of claim 3 wherein individual filter rules are compared to the compare value if the result of the AND operation is equal to the global filter mask.

5. The method of claim 1 and further comprising the step of comparing individual filtering rules of a rule group with fields of a packet by comparing bit positions of an individual rule with corresponding bit positions in the fields.

6. The method of claim 1 wherein global filter masks having a predetermined value are not compared with the fields of a packet.

7. The method of claim 1 and further comprising the step of storing filtering rules in a memory.

8. The method of claim 7 and further comprising the step of defining filtering rules within a rule group using a linked list.

9. The method of claim 7 wherein said memory includes a plurality of memory arrays addressable in parallel and wherein a flag associated with a particular filtering rule indicates if more than one of the arrays is used for that rule.

10. A network element including circuitry for filtering packets according to a plurality of filtering rules, where each filtering rule includes filtering data associated with one or more fields of a received packet, comprising:
circuitry for defining rule groups including a plurality of filtering rules having common associated fields;
circuitry for generating a global filter masks for each rule group, where bit positions in the global filter mask indicate whether each filtering rule in the rule group has a predetermined value at a corresponding bit position;
circuitry for comparing the global filter masks to one or more fields in the packets as packets are received at the network element to determine whether there is a possibility that one of the rules in a corresponding rule group will match data in the fields.

11. The network element of claim 10 and further comprising circuitry for concatenating fields from the packet to form a compare value to compare with a global filter mask.

12. The network element of claim 11 wherein bit positions of the compare value are compared with corresponding positions of an associated global filter mask with a logical AND operation.

13. The network element of claim 12 wherein individual filter rules are compared to the compare value if the result of the AND operation is equal to the global filter mask.

14. The network element of claim 10 and further comprising circuitry for comparing individual filtering rules of a rule group with fields of a packet by comparing bit positions of an individual rule with corresponding bit positions in the fields.

15. The network element of claim 10 wherein global filter masks having a predetermined value are not compared with the fields of a packet.

16. The network element of claim 10 and further comprising a memory circuitry for storing filtering rules.

17. The network element of claim 16 wherein filtering rules are stored in the memory using a linked list structure to define rule groups.

18. The network element of claim 16 wherein said memory includes a plurality of memory arrays addressable in parallel and wherein a flag associated with a particular filtering rule indicates if more than one of the arrays is used for that rule.
